(19) United States
(12) Patent Application Publication
(10) Pub. No.: US 2026/0259045 A1
(43) Pub. Date: Sep. 3, 2026

(54) MEASUREMENT DEVICE AND MEASUREMENT METHOD

(71) Applicant: Lasertec Corporation, Yokohama (JP)

(72) Inventors: Mizuki TAKATSUKI, Yokohama (JP); Nao SATO, Yokohama (JP); Yoshiharu WATANABE, Yokohama (JP); Daichi YOSHIMOTO, Yokohama (JP)

(21) Appl. No.: 19/548,493

(22) Filed: Feb. 24, 2026

(30) Foreign Application Priority Data
Feb. 26, 2025 (JP) 2025-028964

(51) Int. Cl. G01B 11/30

(52) U.S. Cl. CPC G01B 11/303; G01B 11/306

(57) ABSTRACT

A measurement device according to the present disclosure includes: an illumination optical system; a detection optical system; a position control unit configured to control a height position; an acquisition unit configured to acquire, when a preparation sample is irradiated with the illumination light at a plurality of height positions different from each other, relationship information indicating a relationship between the height position and detected intensity based on a result of the detection of the return light by the detector; and a measurement unit configured to obtain, by using the relationship information, surface height information based on a test detection result, the test detection result being the result of the detection of the return light by the detector obtained when the illumination light is applied to the plurality of measurement positions on a test sample while setting the height position for the test sample to a predetermined reference position.

### INCORPORATION BY REFERENCE

This application is based upon and claims the benefit of priority from Japanese Patent Application No. 2025-028964, filed on February 26, 2025, the disclosure of which is incorporated herein in its entirety by reference for all purposes.

### BACKGROUND

The present disclosure relates to a measurement device and a measurement method.

Various devices for measuring the three-dimensional shape of an uneven measurement surface of a sample have been proposed as in the past (e.g., Patent Literature 1).

[Patent Literature 1] Japanese Unexamined Patent Application Publication No. 2020-64127

### SUMMARY

In such measurement devices, it is desired to shorten the measurement time while maintaining the measurement accuracy. The present disclosure has been made in view of the above-described circumstances, and an object thereof is to provide a measurement device and a measurement method capable of quickly measuring the shape of a measurement surface of a sample.

A measurement device according to the present disclosure includes: an illumination optical system configured to apply illumination light to a target object; a detection optical system configured to make a detector detect return light from the target object based on the illumination light; a position control unit configured to control a height position, the height position being a relative position between the target object and a focusing point by the illumination optical system in a height direction; an acquisition unit configured to acquire, when a preparation sample is irradiated, at a predetermined position of the preparation sample, with the illumination light at a plurality of height positions different from each other, relationship information indicating a relationship between the height position and detected intensity based on a result of the detection of the return light by the detector, in which the preparation sample is the target object; and a measurement unit configured to obtain, by using the relationship information, surface height information at the plurality of measurement positions based on a test detection result, the test detection result being the result of the detection of the return light by the detector obtained when the illumination light is applied to the plurality of measurement positions on a test sample while setting the height position for the test sample to a predetermined reference position, in which the test sample is the target object.

A measurement method according to the present disclosure includes, by using a measurement device including an illumination optical system configured to apply illumination light to a target object, and a detection optical system configured to make a detector detect return light from the target object based on the illumination light; controlling a height position, the height position being a relative position between the target object and a focusing point by the illumination optical system in a height direction; acquiring, when a preparation sample is irradiated, at a predetermined position of the preparation sample, with the illumination light at a plurality of height positions different from each other, relationship information indicating a relationship between the height position and detected intensity based on a result of the detection of the return light by the detector, in which the preparation sample is the target object; and obtaining, by using the relationship information, surface height information at the plurality of measurement positions based on a test detection result, the test detection result being the result of the detection of the return light by the detector obtained when the illumination light is applied to the plurality of measurement positions on a test sample while setting the height position for the test sample to a predetermined reference position, in which the test sample is the target object.

According to the present disclosure, it is possible to quickly measure the shape of a measurement surface of a sample.

The above and other objects, features and advantages of the present disclosure will become more fully understood from the detailed description given hereinbelow and the accompanying drawings.

### BRIEF DESCRIPTION OF DRAWINGS

FIG. 1 schematically shows a configuration of a measurement device according to a first embodiment;

FIG. 2 is a diagram for explaining "Z scanning" in a preparation stage;

FIG. 3 is a graph schematically showing a relationship between detected intensity (luminance I) of return light L2 and a height position (Z) acquired in the preparation stage;

FIG. 4 schematically shows the principle of measuring irregularities on a measurement surface of a test sample;

FIG. 5 schematically shows the principle of measuring irregularities on a measurement surface of a test sample;

FIG. 6 schematically shows how two-dimensional scanning of a test sample is performed with illumination light in the XY plane;

FIG. 7 schematically shows how the relative position of the detector relative to the test sample changes when the two-dimensional scanning is performed as shown in FIG. 6;

FIG. 8 is a photograph image of an example of a test sample;

FIG. 9 is a graph showing irregularities at measurement positions on the test sample indicated by a broken line in FIG. 8;

FIG. 10 is an example of an image showing height information of a measurement region on the test sample in gradation;

FIG. 11 is an example of a table showing a plurality of combinations of pieces of height information and pieces of inclination information at a first measurement position;

FIG. 12 is another example of a table showing a plurality of combinations of pieces of height information and pieces of inclination information at a first measurement position;

FIG. 13 is a flow diagram for explaining a measurement method according to the first embodiment; and

FIG. 14 is a schematic diagram showing a change in focus in a measurement device according to a second embodiment.

### DESCRIPTION OF EMBODIMENTS

Embodiments according to the present disclosure will be described hereinafter with reference to the drawings. In order to clarify the explanation, the following description and the drawings are partly omitted and simplified as appropriate. Further, the same elements are assigned the same reference numerals (or symbols) throughout the drawings, and redundant descriptions will be omitted as appropriate. Note that the following description is intended to show preferred embodiments according to the present disclosure, and the scope of the present disclosure is not limited to the embodiments described below.

An embodiment relates to a measurement device for measuring the three- dimensional shape of an uneven measurement surface of a target object. The measurement device according to the embodiment includes a photographing optical system for photographing a sample, including an illumination optical system for applying illumination light to a target object and a detection optical system for making a detector detect return light from the sample based on the illumination light. In the photographing optical system, the light from the focusing point of the illumination light is dominantly detected by the detector.

### First Embodiment

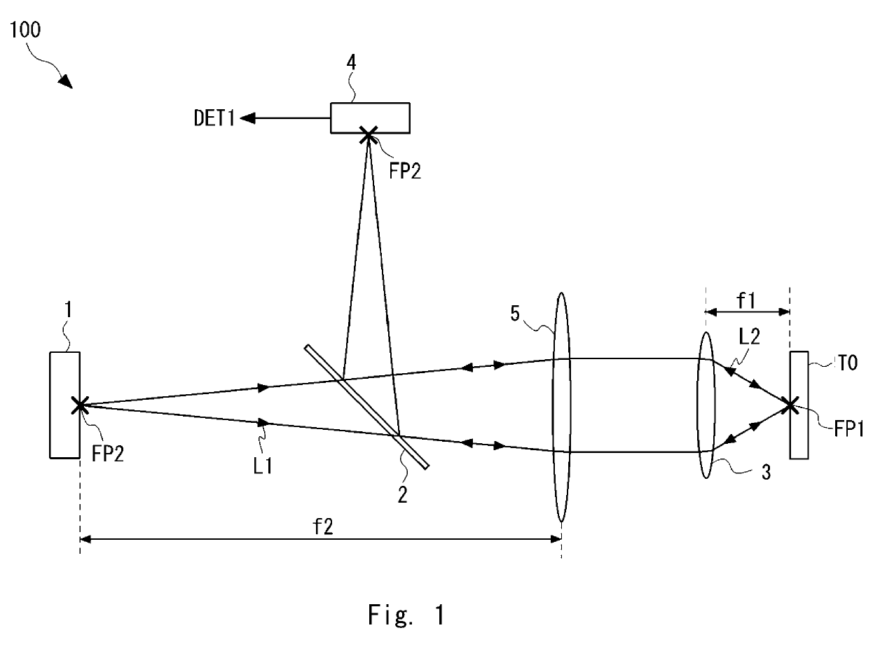

FIG. 1 schematically shows a configuration of a measurement device according to a first embodiment. The measurement device 100 includes, as main components, a light source 1, a beam splitter 2, an objective lens 3, a detector 4, and a lens 5. In the following description, the optical axis direction of the optical system is defined as a Z direction, and directions perpendicular to the optical axis are defined XY directions.

The measurement device 100 has sectioning performance (e.g., a sectioning function) in the Z direction. The measurement device 100 may be, for example, a confocal microscope having confocality along at least one dimension (Z direction). Note that that the measurement device 100 is not limited to confocal optical systems and may be one including other types of sectioning optical systems in which the amount of change in the Z direction is associated with the amount of change in luminance, such as a multiphoton excitation microscope. An example in which the measurement device 100 is a confocal microscope will be described hereinafter.

The light source 1 emits illumination light L1 for irradiating a target object TO therewith. The light source 1 is, for example, a laser light source such as a laser diode. In FIG. 1, the paths of the light in the measurement device 100 are indicated by arrows. The illumination light L1 is applied to the target object T0 through the beam splitter 2, the lens 5, and the objective lens 3. The light emitted from the light source 1 may be emitted as the illumination light L1 through a slit or a pinhole.

The beam splitter 2 is, for example, a half-silvered mirror and lets a part of the light incident thereon pass therethrough. The illumination light L1 that has passed through the beam splitter 2 enters the objective lens 3. The objective lens 3 concentrates the illumination light L1, which has entered therein, and applies the concentrated light to the target object T0. In this way, the illumination light L1 emitted from the light source 1 forms an image on the target object T0. In the case where the light source 1 is a point light source, a point-like spot is formed on the target object T0. That is, the beam splitter 2, the lens 5, and the objective lens 3 can be considered to be an "illumination optical system".

Return light L2 from the target object T0 based on the illumination light L1 enters the detector 4 through the objective lens 3 and the beam splitter 2. The return light L2 that has entered the objective lens 3 from the target object T0 propagates to the beam splitter 2 through the same optical path as that of the illumination light L1. The beam splitter 2 reflects a part of the return light L2 that has entered the beam splitter 2 in the direction toward the detector 4. That is, the objective lens 3 and the beam splitter 2 can be considered to be a "detection optical system" for making the detector 4 detect the return light L2 from the target object T0 based on the illumination light L1. In the first embodiment, the photographing optical system including the illumination optical system for applying the illumination light L1 from the light source 1 to the target object T0, and the detection optical system for guiding the return light L2 from the target object T0 to the detector 4 constitutes a confocal optical system.

The return light L2 could be reflected light that is generated as the target object T0 is illuminated with the illumination light L1. Note that the return light L2 may be any of various light rays that is generated as the target object T0 is illuminated with the illumination light L1, such as reflected light, transmitted light, scattered light, and fluorescence.

Note that although it is not shown here, the target object T0 is placed on a stage. The stage is, for example, a movable stage such as a rotating stage or an XYZ stage. The illuminated position on the target object T0 is changed by driving the stage. The detector 4 detects return light L2 coming from a plurality of measurement positions on the target object T0, which are irradiation positions of the illumination light L1. In other words, the stage can function as an example of a "scanning control unit" for moving the region on the target object T0 where an image is formed by the detector 4 relative to the target object T0. Note that how the scanning control unit is configured is not limited to any particular ways as long as the relative position of the target object T0 and the region on the target object T0 where an image is formed by the detector 4 can be controlled. For example, the target object T0 may be two-dimensionally scanned by the illumination light by using a galvano-mirror or the like.

Further, by driving the stage in the Z direction (optical axis direction), the distance between the objective lens 3 and the target object T0 changes. In this way, the focusing point can be adjusted, and the target object T0 can be moved to the in- focus point. The stage can function as an example of a "position control unit" for controlling the height position, which is the relative position between the target object T0 and the focusing point by the illumination optical system in the height direction. The target object T0 may be held by a holding part embodied by a pinching mechanism, a robot arm, or the like in addition to the stage. That is, the stage is an example of the holding part for holding the target object T0.

The objective lens 3 is configured to be able to be driven along the irradiation direction of the illumination light L1 to the target object T0 (i.e., along Z direction) so that the focal point FP1 coincides with the target object T0. The focal length of the objective lens 3 is represented by f1. The control unit for driving the objective lens 3 in the Z direction can function as another example of the above- described "position control unit" for controlling the height position. In the following description, an example of the control of the height position by changing the position of the objective lens 3 will be described.

Note that the focal point FP2 of the lens 5 coincides with the exit point of the illumination light L1 from the light source 1. The focal length of the lens 5 is represented by f2. The focal point FP2 of the return light L2 reflected by the beam splitter 2 is a position conjugate with the exit point of the illumination light L1 from the light source 1.

The detector 4 is provided at a position conjugate with the focusing point of the illumination light L1 to the target object T0 by the objective lens 3. The detector 4 outputs a detection signal DETl corresponding to the detected intensity (luminance) of the return light L2 coming from the target object T0. Note that a pinhole, a slit, or the like may be disposed at a position conjugate with the focusing point of the objective lens 3, and the detector 4 may detect return light that has passed through the pinhole, the slit, or the like.

The detector 4 may be a sensor including a plurality of pixels (light receiving elements) arranged in one direction. The detector 4 is, for example, a line sensor including 1,024 pixels. In this case, the illumination light L1 is formed in a line shape through a slit (not shown). The pixels of the detector 4 are arranged along the direction corresponding to the irradiation region of the line-shaped illumination light L1. A CCD (Charge Coupled Device) or a CMOS (Complementary Metal Oxide Semiconductor) sensor is used as the detector 4. Each of the pixels outputs a detection signal DETl corresponding to the amount of light received in the pixel. The detection signal DETl is input to a processing device (not shown).

The processing device includes a processor, a memory, and a storage device as its components (not shown). In the storage device, a program for causing a computer to perform the measurement method according to the first embodiment is stored. This processor can load the program from the storage device onto the memory and execute the loaded computer program. In this way, the processor implements the functions of the acquisition unit, the measurement unit, the output unit, and the like. The operation of each function will be described below in detail.

Note that the components of the processing device may be implemented by dedicated hardware. Further, some or all of the components may be implemented, for example, by a general-purpose or dedicated circuit, a processor, or a combination thereof. These components may be formed by a single computer chip or by a plurality of computer chips connected to each other through a bus. Some or all of the components of each unit may be implemented by a combination of the above- mentioned circuitry or the like and a program(s). Further, for the processor, a CPU (Central Processing Unit), a GPU (Graphics Processing Unit), or the like may be used.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (Registered Trademark) disc or other optical disc storages, a magnetic cassette, magnetic tape, and a magnetic disc storage or other magnetic storage devices. The program may be transmitted on various types of transitory computer readable media or communication media. By way of example rather than limitation, transitory computer readable media or communication media may include electrical, optical, acoustic, or other forms of propagation signals.

The measurement device 100 can enter (1) a preparation stage and (2) a measurement stage.

### Preparation Stage

In the preparation stage, a preparation sample T1 is used as the target object T0. At a predetermined position on the preparation sample T1, the measurement device 100 irradiates the preparation sample T1 with the illumination light L1 at a plurality of height positions different from each other. The acquisition unit acquires relationship information indicating a relationship between the height position and the detected intensity based on the result of the detection of the return light L2 by the detector 4 (hereinafter referred to as a "preparation detection result") in this state. Note that the "height position" means a relative position between a specific point on the target object T0 (e.g., the surface at the measurement position) and the focusing point (focal point FP1) by the illumination optical system in the height direction. Note that the height direction may mean the optical axis direction of the objective lens 3 or may mean the normal direction of the main surface of the target object T0.

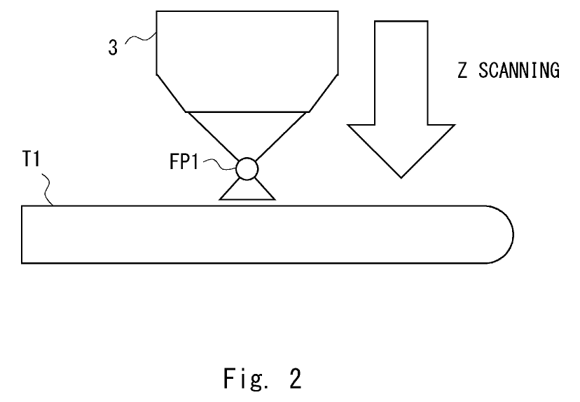

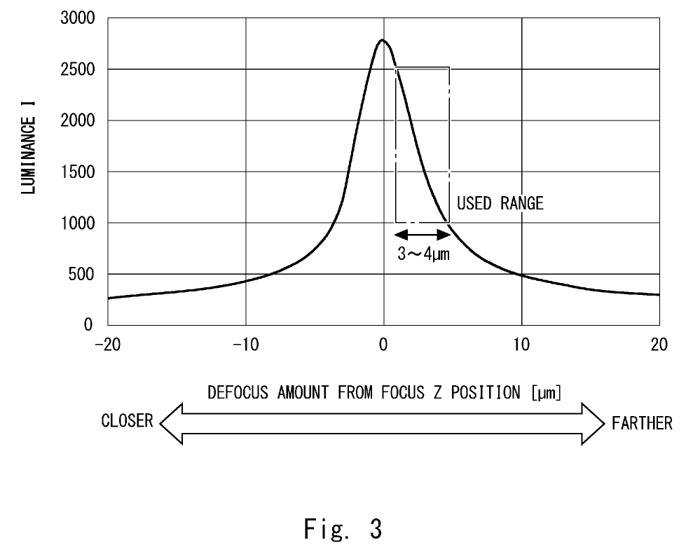

FIG. 2 is a diagram for explaining "Z scanning" in the preparation stage. The "Z scanning" refers to an operation in which the height position, which is the relative position between the preparation sample T1 and the focusing point (focal point FP1) by the illumination optical system in the height direction, is continuously changed. As shown in FIG. 2, in this operation, the height position is changed by changing (i.e., moving) the objective lens 3 in the Z-direction. For example, the focal point FPi is moved upward and away from the preparation sample T1 by moving the objective lens 3 away from the preparation sample T1. Further, the focal point FPi is moved downward and away from the preparation sample T1 by moving the objective lens 3 closer to the preparation sample T1. In this way, a plurality of detection signals DETi at a plurality of respective height positions are acquired. FIG. 3 is a graph schematically showing the relationship between the detected intensity (luminance I) of the return light L2 and the height position (Z) acquired in the preparation stage. In FIG. 3, the horizontal axis indicates the height position, and the direction in which the objective lens 3 is moved away from the preparation sample T1 (the direction in which the focal point FPi is moved upward and away from the preparation sample T1) corresponds to the positive side on the horizontal axis. In FIG. 3, the vertical axis indicates the detected intensity (luminance I) of the return light L2. This relationship information indicating the relationship between the height position and the detected intensity is also called an "I-Z curve".

The position of the objective lens 3 when the target object TO is at the in-focus point of the objective lens 3 is referred to as a focus Z position. Then, it can be said that the "height position" indicates the amount of the defocus (μm) (hereinafter also referred to as the defocus amount (μm)) from the focus Z position. As the defocus amount becomes larger than zero, it indicates a state in which the objective lens 3 is moved away from the preparation sample T1 (the objective lens 3 is moved upward). On the other hand, as the defocus amount becomes smaller than zero, it indicates a state in which the objective lens 3 is moved closer to the preparation sample T1 (the objective lens 3 is moved downward).

As shown in FIG. 3, the relationship between the height position and the detected intensity is such a relationship that the detected intensity has a peak when the "height position" is a specific height position. In the I-Z curve shown in FIG. 3, the detected intensity has a peak when the defocus amount (μm) from the focus Z position is zero (i.e., when the focal point FPi is on the preparation sample T1). It is known that the characteristics of the I-Z curve depend on the wavelength of the illumination light L1 and the numerical aperture (NA) of the objective lens 3. The shorter the wavelength of the illumination light L1 is and the higher the numerical aperture of the objective lens 3 is, the steeper the rise and fall of the I-Z curve become. The wavelength of the illumination light L1 and the numerical aperture of the objective lens 3 are selected as appropriate in order to improve the sectioning performance in the Z direction.

Note that it is preferred that in the relationship between the height position and the detected intensity, the acquisition unit acquires, as the relationship information, a part belonging to either a lower height side or a higher height side than the specific height position. Specifically, the acquisition unit acquires, as the relationship information, a part belonging to either a lower height side or a higher height side than the height position where the detected intensity has a peak in the I- Z curve.

In other words, the relationship information acquired by the acquisition unit may indicate such a relationship that the detected intensity decreases as the height position increases (i.e., the objective lens 3 is moved away from the preparation sample T1). In FIG. 3, such relationship information is an I-Z curve in a range in which the defocus amount is larger on the positive side of the focus Z position (defocus amount > 0). Hereinafter, an I-Z curve in a range in which the defocus amount is larger than zero (defocus amount > 0) is referred to as a "right side of the I-Z curve".

Alternatively, the relationship information acquired by the acquisition unit may indicate such a relationship that the detected intensity increases as the height position increases (i.e., the objective lens 3 is moved away from the preparation sample T1.). In FIG. 3, such relationship information is an I-Z curve in a range in which the defocus amount is larger on the negative side than at the focus Z position (defocus amount < 0). Hereinafter, an I-Z curve in a range in which the defocus amount is smaller than zero (defocus amount < 0) is referred to as a "left side of the I-Z curve".

By using a range in which the I-Z curve monotonically increases or decreases as the relationship information as described above, the detected intensity and the height position correspond to each other in a one-to-one manner. In this way, when the detected intensity (luminance) is acquired in the measurement stage, one piece of height information can be specified. For example, as shown in FIG. 3, a range of 3 to 4μm indicated by a dash-dot line in the I-Z curve represented by a solid line by the objective lens 3 having a certain numerical aperture can be used as the used range which is used as the relationship information.

From the acquired relationship information, the acquisition unit creates a correspondence table in which the detected intensity (luminance) and the height information at the measurement position on the test sample T2 correspond to each other in a one-to-one manner. The correspondence table is used when the height information at the measurement position on the test sample T2 is obtained by the measurement unit. That is, in the first embodiment, the height position of the objective lens 3 is converted into the height information at the measurement position based on the detected intensity at the measurement position on the test sample T2.

When the detector 4 includes a plurality of pixels as described above, the relationship information between the height position and the detected intensity differs on a pixel-by-pixel due to the aberration. For example, it is known that among the plurality of pixels of the detector 4 arranged in one direction, the I-Z curve of pixels disposed at or near the center is sharper than the I-Z curve of pixels disposed at both ends. Therefore, in this case, it is preferred that a plurality of pieces of relationship information corresponding to a plurality of respective pixels are acquired.

### Measurement Stage

In the measurement stage, a test sample T2 is used as the target object T0. Note that the reflectance of the test sample T2 for the illumination light L1 is roughly equal as that of the preparation sample T1 for the illumination light L1. For example, the test sample T2 could be the same object as the preparation sample T1.

The measurement device 100 sets, by using the above-described relationship information, the relative position between the test sample T2 and the focusing point (focal point FPi) by the illumination optical system in the height direction (referred to as the height position of the test sample T2) to a reference position Z0, which is a predetermined height position, and applies the illumination light L1 to a plurality of measurement positions on the test sample T2. The measurement unit obtains height information at each of the plurality of measurement positions based on the result of the detection of the return light L2 by the detector 4 (hereinafter referred to as a "test detection result") in this state. Specifically, the measurement unit refers to the above-described correspondence table and obtains, for each of the measurement positions, the corresponding height information based on the "luminance" indicated by the detection result at the measurement position. By obtaining a plurality of pieces of height information at the plurality of measurement positions, the measurement device 100 can measure irregularities on the measurement surface of the test sample T2.

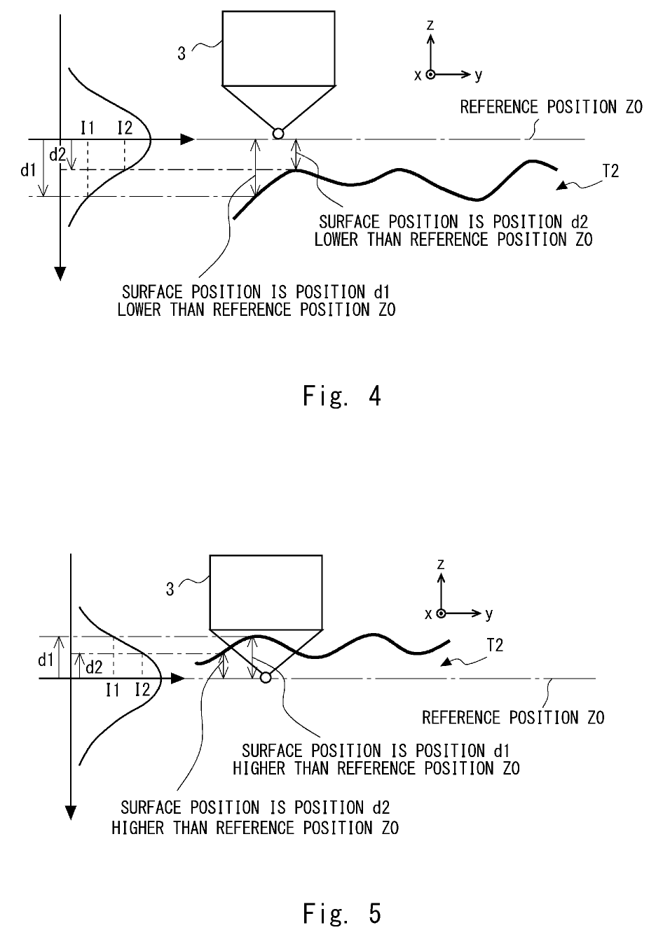

FIGS. 4 and 5 schematically show a principle based on which the measurement unit measures, by referring to the above-described correspondence table, irregularities on the measurement surface of the test sample T2 based on the "luminance" indicated by the detection results at the respective measurement positions.

FIG. 4 is an example in which the "right side of the I-Z curve" is used as the relationship information (correspondence table). For the sake of explanation, the "I-Z curve" is rotated clockwise by 900 and positioned near the test sample T2 so that the position (focus Z position) at which the luminance of the" I-Z curve" has a peak coincides with the reference position Z0.

The luminance of a pixel p1 at a given position when the illumination light L1 is applied to a plurality of measurement positions on the test sample T2 by scanning it in the Y-axis direction is represented by I1. Then, it is seen that the surface position of the test sample T2 corresponding to the pixel p1 is a distance d1 away from the reference position Z0 based on the relationship information. In this way, the measurement unit can measure (i.e., determine) that the surface position of the test sample T2 corresponding to the pixel p1 is a distance d1 away from the reference position Z0 in direction away from objective lens 3.

Further, the luminance of a pixel at a given position p2 when the illumination light L1 is applied to the plurality of measurement positions on the test sample T2 by scanning it in the Y-axis direction is represented by I2 (I2> I1). It is seen that the surface position of the test sample T2 corresponding to the pixel p2 is a distance d2 away from the reference position Z0 based on the relationship information. In this way, the measurement unit can measure (i.e., determine) that the surface position of the test sample T2 corresponding to the pixel p2 is a distance d2 away from the reference position Z0 in direction away from the objective lens 3.

FIG. 5 is an example in which the "left side of the I-Z curve" is used as the relationship information (correspondence table). For the sake of explanation, the"I-Z curve" is rotated clockwise by 900 and positioned near the test sample T2 so that the position (focus Z position) at which the luminance of the" I-Z curve" has a peak coincides with the reference position Z0.

The luminance of a pixel pl at a given position when the illumination light L1 is applied to a plurality of measurement positions on the test sample T2 by scanning it in the Y-axis direction is represented by I1. Then, it is seen that the surface position of the test sample T2 corresponding to the pixel p1 is a distance d1 away from the reference position Z0 based on the relationship information. In this way, the measurement unit can measure (i.e., determine) that the surface position of the test sample T2 corresponding to the pixel p1 is a distance d1 away from the reference position Z0 in direction toward the object lens 3.

Further, the luminance of a pixel at a given position p2 when the illumination light L1 is applied to the plurality of measurement positions on the test sample T2 by scanning it in the Y-axis direction is represented by I2 (I2> I1), and then it is seen that the surface position of the test sample T2 corresponding to the pixel p2 is a distance d2 away from the reference position Z0 based on the relationship information. In this way, the measurement unit can measure (i.e., determine) that the surface position of the test sample T2 corresponding to the pixel p2 is a distance d2 away from the reference position Z0 in direction toward the objective lens.

In the case where the detector 4 includes a plurality of pixels as described above, it is preferred that a plurality of pieces of relationship information corresponding to a plurality of respective pixels are acquired. In FIGS. 4 and 5, a plurality of pixels may be arranged in the X-axis direction orthogonal to the Y- and Z-axes (more precisely, a plurality of regions on the test sample T2 where a plurality of images are formed in a plurality of pixels may be arranged in the X-axis direction). The relationship information may be acquired for each of the plurality of pixels. Even in the case where the height of the surface of the test sample T2 is measured by using a plurality of pieces of relationship information each of which differs according to a respective one of a plurality of pixels, the height of the surface of the test sample T2 can be measured by the principle described above with reference to FIGS. 4 and 5 under the respective pixels and the respective pieces of relationship information.

In both FIGS. 4 and 5, the distance d2 from the reference position Z when I2 is larger than I1 (I2>I1) is smaller than d1 (i.e., d2<d1). However, according to FIG. 4, the higher the luminance of the pixel is, the higher the surface of the test sample T2 corresponding to that pixel is (i.e., the closer to the objective lens). On the other hand, according to FIG. 5, the higher the luminance of the pixel is, the lower the surface the test sample T2 corresponding to that pixel is (i.e., the farther from the objective lens). In consideration of such characteristics, i.e., how the difference in the luminance appears in the difference in the surface height, it is preferred to selectively use the "right side of the I-Z curve" and the "left side of the I-Z curve". This selective use will be described later.

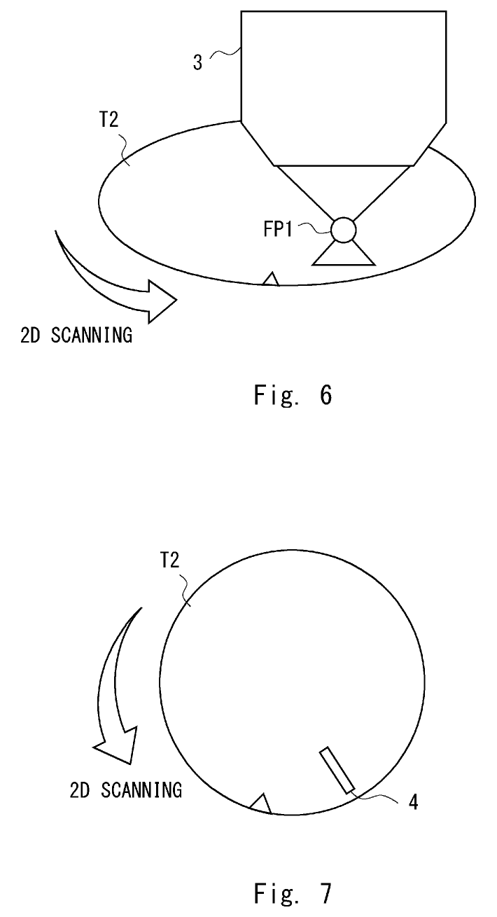

FIG. 6 schematically shows how the two-dimensional scanning (2D scanning) on the test sample T2 is performed with illumination light L1 in the XY plane. FIG. 7 schematically shows how the relative position of the region on the test sample T2 of which an image is formed in the detector 4 changes when the two- dimensional scanning is performed as shown in FIG. 6. In the example shown in FIGS. 6 and 7, the test sample T2 is placed on a rotating stage. As described above, in the measurement stage, the height position of the test sample T2 is set to the predetermined reference position Z0. Therefore, as shown in FIG. 6, the two- dimensional scanning on the test sample T2 with the illumination light L1 is performed by rotating the stage in the circumferential direction without moving the objective lens 3 of which the position has been adjusted so that the height position of the test sample T2 coincides with the predetermined reference position Z0.

Return light L2 from the test sample T2 is detected by the detector 4 including a plurality of pixels arranged in one direction. By rotating the stage in the circumferential direction, the test sample T2 is moved in such a manner that the test sample T2 is moved, with respect to the region of which an image is formed in the detector 4, in the direction (Y-axis direction) orthogonal to the direction (X-axis direction) in which the plurality of pixels are arranged. Based on the above- described principle, the measurement unit can obtain, for each of the pixels, height information based on the test detection result of the pixel by using the piece of relationship information corresponding to the pixel. As described above, according to the first embodiment, it is possible to measure irregularities on the measurement surface of the test sample T2 in a short time by just performing the two-dimensional scanning in the XY directions without performing Z scanning for the plurality of measurement positions.

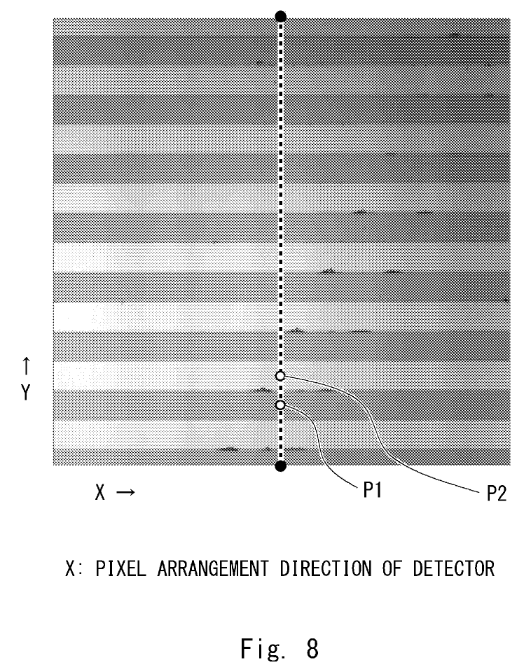

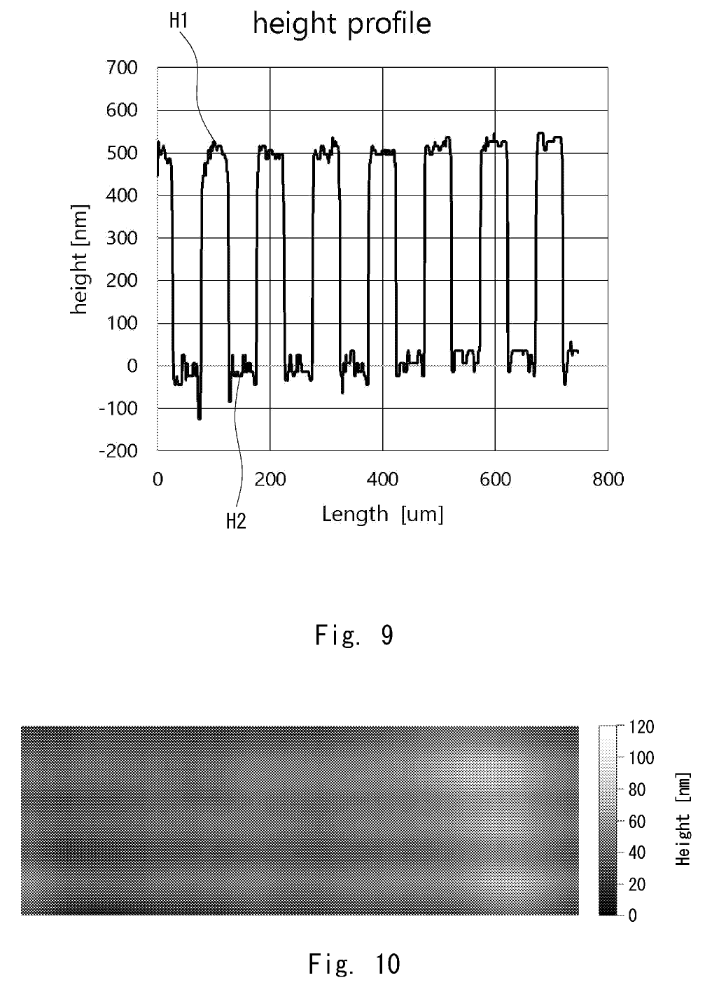

FIG. 8 is a photograph image of an example of the test sample T2 photographed by the detector 4. The photograph image is a two-dimensional confocal image in the XY directions. In FIG. 8, it is assumed that the plurality of pixels are arranged in the X direction in the detector 4. Therefore, in the example shown in FIG. 8, the scanning is performed along the Y direction. In FIG. 8, dark parts indicate the luminance of pixels having relatively low luminance, and bright parts indicate the luminance of pixels having relatively high luminance. FIG. 9 is a graph showing irregularities at the measurement positions on the test sample T2 indicated by the broken line in FIG. 8.

In FIG. 9, the horizontal axis indicates the length (μm) in the Y direction obtained by converting the positions of the pixels located on the broken line in the photograph image in FIG. 8 into the dimensions of the test sample T2, and the vertical axis indicates the height (μm). In the measurement method according to the first embodiment, the luminance indicated by the detection signal DET1 output from the detector 4 (the luminance of the pixels located on the broken line in FIG. 8) is converted into the heights by using the correspondence table under the above-described principle. In this way, the height at each measurement position in the measurement region on the test sample T2 is obtained.

In the example shown in FIGS. 8 and 9, the left side of the I-Z curve is used. That is, the position of the objective lens 3 is adjusted so that the reference position Z0 is located inside the test sample T2. The luminance Il of the pixel p1 shown in FIG. 8 is lower than the luminance I2 of the pixel p2. As can be seen from FIG. 5, the surface of the test sample T2 at the position corresponding to the pixel pl is farther from the reference position Z0 than the surface of the test sample T2 at the position corresponding to the pixel p2 is (d1>d2), and the height H1 of the surface of the test sample T2 at the position corresponding to the pixel p1 is higher (closer to the objective lens) than the height H2 of the surface of the test sample T2 at the position corresponding to the pixel p2 is. Specifically, the height H1 of the surface of the test sample T2 at the position corresponding to the pixel p1 is a position a distance d1 higher than the reference position Z0, and the height H2 of the surface of the test sample T2 at the position corresponding to the pixel p2 is a position a distance d2 (d1>d2) higher than the reference position Z0.

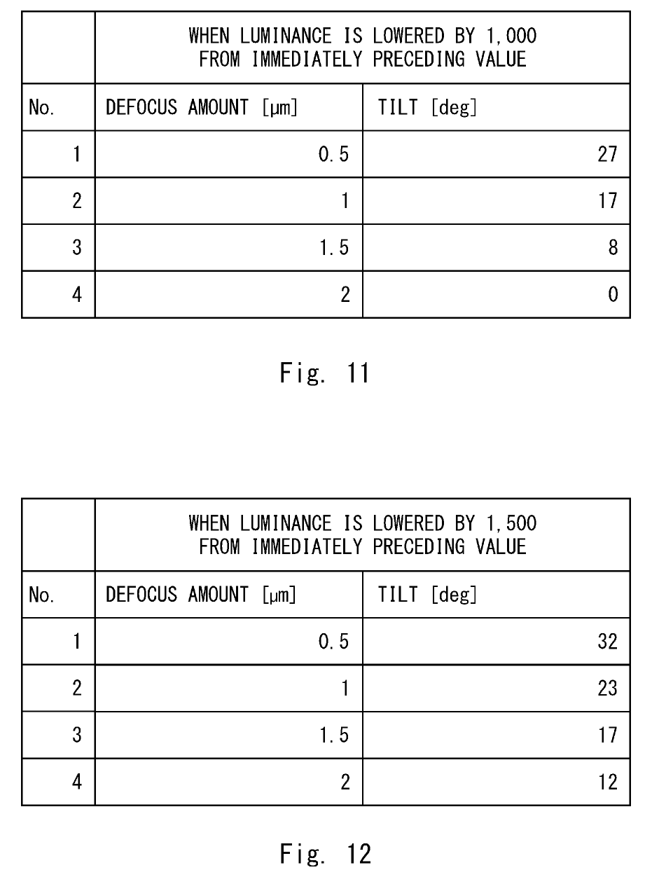

The output unit outputs an image in which height information at each measurement position on the test sample T2 is expressed in gradation, for example, on an XY plane in which positions of a plurality of pixels of the detector 4 are represented by X coordinates and a plurality of positions in the scanning direction are represented by Y coordinates. FIG. 10 is an example of an image in which the height information of the measurement region on the test sample T2 is expressed in gradation. As described above, by expressing irregularities on the measurement surface of the test sample T2 in gradation, the surface shape of the test sample T2 can be recognized more intuitively, so that the presence/absence of an abnormality can be easily determined.

Further, the processing device may further include a determination unit for determining whether or not the test detection result exceeds a predetermined threshold. For example, when the test detection result, i.e., the luminance of a given pixel, changes such that it crosses the peak of the I-Z curve shown in FIG. 3, the relationship between the detected intensity and the height information is not the one- to-one relationship, so that the height information at the measurement position cannot be obtained.

Therefore, in order to prevent the test detection result from crossing the peak , for example, the detected intensity (luminance) at the minimum defocus amount in the range in which the I-Z curve is used as the relationship information can be set as the threshold. For example, "2,500", i.e., the detected intensity at the minimum defocus amount in the range to be used, shown in FIG. 3 can be set as the threshold.

When the determination unit determines that the test detection result (i.e., the luminance of an arbitrary pixel) exceeds the predetermined threshold (affirmative determination), the measurement unit can stop, as a measurement error, the calculation of the height information based on the test detection result at and after the affirmative determination. Further, when the determination unit has made an affirmative determination, the position control unit may control the height position so that a height position different from the reference position at the time of the affirmative determination is set as a new reference position.

For example, when the relationship information shows a relationship in which the detected intensity increases as the height position increases (the left side of the I-Z curve), the position control unit can control the relative position between the test sample and the focusing point in the height direction so that a height position lower than the reference position Z0 at the time of the affirmative determination (i.e., a position where the test sample T2 and the objective lens 3 are closer to each other) is set as a new reference position Z0. Further, as another example, when the relationship information shows a relationship in which the detected intensity decreases as the height position increases (the right side of the I-Z curve), the position control unit can control the relative position between the test sample and the focusing point in the height direction so that a height position higher than the reference position Z0 at the time of the affirmative determination (i.e., a position where the test sample T2 and the objective lens 3 are farther from each other) is set as a new reference position Z0. In this way, in the subsequent measurement of the surface shape of the test sample T2, it is possible to prevent the test detection result from exceeding the predetermined threshold and thereby to prevent a measurement error from occurring.

As described above, it is preferred to selectively use the "right side of the I-Z curve" and the "left side of the I-Z curve" in consideration of how the difference in the luminance appears in the difference in the surface height. Note that when the test detection result, i.e., the luminance of a given pixel, changes such that it crosses the peak of the I-Z curve shown in FIG. 3, it becomes difficult to obtain the height information at the measurement position. Based on this fact, the relationship information that the acquisition unit acquires may be determined according to the surface shape of the test sample T2 to be measured as will be described below.

For example, if the "left side of the I-Z curve" is used when the test sample T2 has a measurement surface in which a recess is formed on the flat surface, the detected intensity increases as the depth (depression amount) of the recess increases, so that it gets close to or reaches the peak luminance. Therefore, when a recess in the test sample T2 is measured, the measurement unit preferably obtains the height information at the measurement position on the test sample T2 based on the relationship information showing a relationship in which the detected intensity decreases as the height position increases (i.e., based on the right side of the I-Z curve). Further, when the right side of the I-Z curve is used as the relationship information, it is preferred that the position of the reference position Z0 has been adjusted to a position higher than the surface layer of the test sample T2.

On the other hand, if the "right side of the I-Z curve" is used when the test sample T2 has a measurement surface in which a protrusion is formed on the flat surface, the detected intensity increases as the height (elevation amount) of the protrusion increases, so that it gets close to or reaches the peak luminance. Therefore, when a protrusion in the test sample T2 is measured, the measurement unit preferably obtains the height information at the measurement position on the test sample T2 based on the relationship information showing a relationship in which the detected intensity increases as the height position increases (i.e., based on the left side of the I-Z curve). Further, when the left side of the I-Z curve is used as the relationship information, it is preferred that the position of the reference position Z0 has been adjusted to a deeper point inside the test sample T2.

As described above, in the measurement method according to the first embodiment, the height information of the measurement surface is obtained by using the fact that the detected intensity changes when the test sample T2 which is originally in the in-focus point of the objective lens 3 (the focused state) is brought into an out-of-focus state. However, it is known that the detected intensity changes not only due to the out-of-focus but also due to the tilt of the test sample T2. In general, in a measurement device using a confocal optical system, roughly the whole illumination light L1 applied to the test sample T2 is detected as the return light L2 by the detector 4. However, it is presumed that when the measurement surface of the test sample T2 is tilted, a part of the return light L2 travels toward the outside of the objective lens 3, so that the detected intensity decreases.

Therefore, the measurement unit can specify one of a plurality of combinations of pieces of height information and pieces of tilt information at a first measurement position, specified based on the test detection result, by using the height information and tilt information at a second measurement position close to the first measurement position. Note that the "height information and tilt information at a second measurement position close to the first measurement position" can be the height information and tilt information at a second measurement position that is spatially close to the first measurement position but different from the first measurement position. For example, it is assumed that when the two-dimensional scanning is performed, the measurement at the second measurement position is performed immediately before the measurement at the first measurement position. That is, the test detection result at the second measurement position is output immediately before the test detection result at the first measurement position is output.

Specifically, the measurement unit can first select a table in which a plurality of combinations of pieces of height information and pieces of tilt information at the first measurement position are stored based on the test detection result (luminance) at the first measurement position. FIGS. 11 and 12 are tables showing a plurality of combinations of defocus amounts (pieces of height information) and tilts (pieces of tilt information) of the test sample T2. FIG. 11 shows a plurality of combinations of pieces of height information and pieces of tilt information at the first measurement position when the luminance at the first measurement position has decreased by 1,000 from the immediately preceding detection value (i.e., the luminance at the second measurement position).

FIG. 12 shows a plurality of combinations of pieces of height information and pieces of tilt information at the first measurement position when the luminance at the first measurement position has decreased by 1,500 from the immediately preceding detection value (i.e., the luminance at the second measurement position). For example, the measurement unit can select the table shown in FIG. 11 when the difference between the detected intensity at the first measurement position and that at the second measurement position is 1,000. Note that the tables shown in FIGS. 11 and 12 are merely examples. The measurement device 100 may have two or more tables each showing a plurality of combinations of pieces of height information and pieces of tilt information according to the difference between the detected intensity at the first measurement position and that at the second measurement position.

Next, the measurement unit can specify one of the plurality of combinations included (i.e., recorded) in the table shown in FIG. 11 by using the height information and tilt information at the second measurement position. Regarding the measurement device 100, it is assumed that the object to be measured is a test sample T2 of which the measurement surface changes in a continuous manner. Therefore, the first measurement position and the second measurement position are smoothly connected to each other. Therefore, the measurement unit specifies, by using the height information and tilt information at the second measurement position, one combination in which the second measurement position and the first measurement position are smoothly connected to each other from among the plurality of combinations included (i.e., recorded) in the table shown in FIG. 11.

As described above, the measurement unit can obtain the height information and tilt information at the first measurement position in such a manner that a newly measured first measurement position is continuously connected with an adjacent second measurement position. In other words, the measurement unit can select one with which the height information and tilt information at the first measurement position best matches the height information and tilt information at the second measurement position. In this way, it is possible to infer whether the change in the detected intensity at the first measurement position is caused by the tilt of the test sample T2 or is caused by the defocus thereof, and to measure the surface shape of the test sample T2 according to this inference.

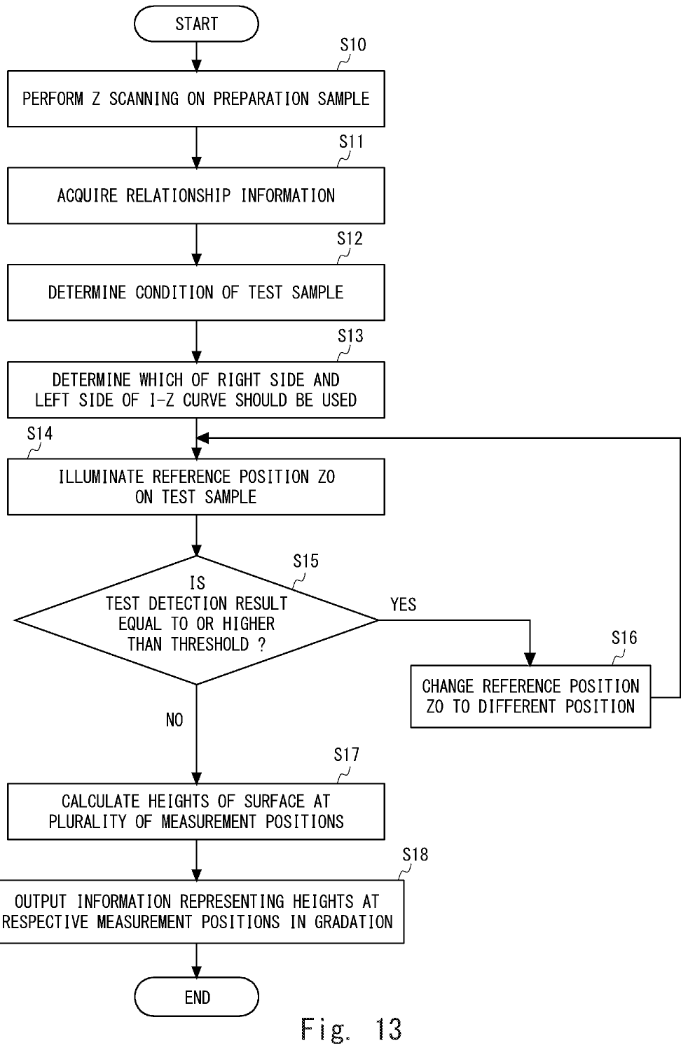

FIG. 13 is a flowchart for explaining a measurement method according to the first embodiment. In this measurement method, the measurement device 100 including the illumination optical system and the detection optical system described above is used. The measurement device 100 first performs Z scanning for a preparation sample T1 (Step S10). Specifically, the measurement device 100 changes the height position, which is the relative position between the preparation sample T1 and the focusing point (focal point FPi) in the height direction at a predetermined position on the preparation sample T1. Then, the measurement device 100 acquires relationship information based on the result of the detection of return light L2 that is obtained by the detector 4 when the preparation sample T1 is irradiated with illumination light L1 at a plurality of height positions different from each other (Step S11). In this way, the I-Z curve shown in FIG. 3 is obtained as the relationship information.

Next, the condition of the test sample T2 is determined (Step S12). As described above, when the test sample T2 has a recess, the right side of the I-Z curve is preferably used as the relationship information. Further, when the test sample T2 has a protrusion, the left side of the I-Z curve is preferably used as the relationship information. Therefore, in order to determine which of the "right side of the I-Z curve" and the "left side of the I-Z curve" should be acquired as the relationship information, a condition determination is made, i.e., it is determined whether which of recesses and protrusions are more abundant on the surface of the test sample T2. Note that this step is an optional process and hence may be omitted (e.g., skipped). Then, it is determined which of the right side of the I-Z curve and the left side of the I-Z curve should be used as the relationship information (Step S13). The steps S10 to S13 show processes that are performed by the measurement device 100 in the preparation stage.

After that, the measurement device 100 proceeds to processes in the test stage. Firstly, the measurement device 100 sets the height position for the test sample T2 to the reference position Z0, i.e., as the predetermined height position, and irradiates the measurement position on the test sample T2 with the illumination light L1 (Step S14). The measurement device 100 can irradiate a plurality of measurement positions on the test sample T2 with the illumination light L1 by two- dimensionally scanning the test sample T2 with the illumination light L1. In this way, a test detection result when the plurality of measurement positions on the test sample T2 are irradiated with the illumination light L1 can be obtained.

Next, as an optional step, the measurement device 100 determines whether or not the test detection result exceeds a predetermined threshold (Step S15). Note that when it is obvious that the test detection result does not exceed the predetermined threshold, the step S15 may be omitted (e.g., skipped). When it is determined that the test detection result exceeds the threshold (Step S15, YES), the measurement device 100 controls the height position so that a height position different from the reference position at the time of the affirmative determination is set as a new reference position (Step S16), and the process returns to the step S15. On the other hand, when it is determined that the test detection result does not exceed the threshold (Step S15, NO), the measurement device 100 can calculate surface height information at the plurality of measurement positions based on the test detection result obtained when the plurality of measurement positions are irradiated with the illumination light L1 by using the relationship information determined in the step S13 (Step S17). Then, if necessary, the measurement device 100 can output information in which heights at respective measurement positions on the test sample T2 are expressed in gradation (Step S18).

### Second Embodiment

A measurement device according to a second embodiment will be described. The position control unit described in the first embodiment is not limited to the above-described example as long as it can change the relative position between the target object T0 and the focusing point by the illumination optical system in the height direction. In the measurement device according to the second embodiment, the illumination optical system includes a variable focus optical element, and the position control unit changes the relative position between the target object T0 and the focusing point (focus FP1) of the illumination optical system in the height direction by driving the variable focus optical element of the illumination optical system.

The variable focus optical element may be a combination of a plurality of mirrors, a combination of a plurality of lenses, or a single lens of which the focal length can be changed by changing its shape. The variable focus optical element may include the objective lens 3. The position control unit changes the focusing point (focal point FP1) of the illumination optical system by changing the position of at least one of the plurality of lenses or mirrors, or changing the shape of the variable focus lens.

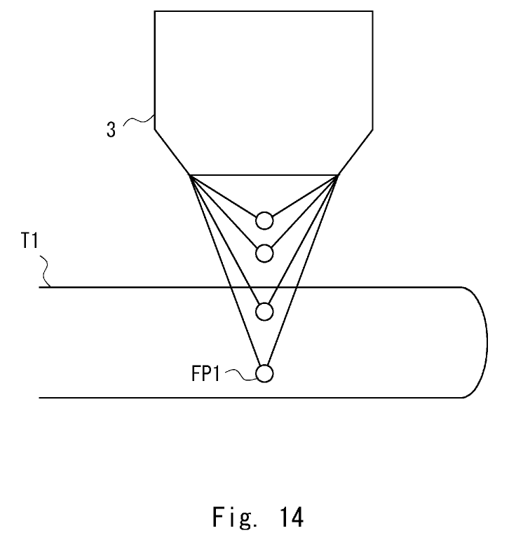

FIG. 14 is a schematic diagram showing changes in the focal point FP1 in the measurement device according to the second embodiment. In the measurement device according to the second embodiment, the relative position between the target object T0 and the objective lens 3 in the height direction is fixed. Then, relationship information showing a relationship between the height position and the detected intensity is acquired based on the result of the detection of the return light by the detector obtained when the preparation sample T1 is irradiated with the illumination light at a plurality of height positions different from each other by changing the position of the focal point FP1 of the objective lens 3.

Note that the direction in which the focal point FP1 approaches the objective lens 3 in FIG. 14 corresponds to the positive side on the horizontal axis in the graph shown in FIG. 3. That is, in the measurement device according to the second embodiment, increasing the "height position" (increasing the relative position between the target object T0 and the focusing point (focal point FP1) by the illumination optical system in the height direction) corresponds to moving the focal point FP1 closer to the objective lens 3. On the other hand, in the measurement device according to the second embodiment, decreasing the "height position" (decreasing the relative position between the target object T0 and the focusing point (focal point FP1) by the illumination optical system in the height direction) corresponds to moving the focal point FP1 further away from the objective lens 3. The other components/structures are similar to those of the measurement device according to the first embodiment and have already been described in the description above.

Although the present disclosure has been described with reference to embodiments, the present disclosure is not limited to the embodiments described above. Various modifications that can be understood by those skilled in the art may be made to the structure and details of the present disclosure within the scope of the present disclosure. Then, the embodiments may be combined with one another as appropriate.

The drawings are merely examples for describing one or more embodiments. Each drawing is not associated with only one particular embodiment, but may be associated with one or more other embodiments. As will be understood by those skilled in the art, various features and steps described above with reference to any one of the drawings may be combined with features or steps shown in one or more of the other drawings in order to create, for example, an embodiment that is not explicitly shown nor described herein. Not all of the features or steps shown in any one of the drawings in order to describe an example embodiment are indispensable, and some of the features or steps may be omitted. The order of the steps shown in any one of the drawings may be changed as appropriate.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A measurement device comprising:
an illumination optical system configured to apply illumination light to a target object;
a detection optical system configured to make a detector detect return light from the target object based on the illumination light;
a position control unit configured to control a height position, the height position being a relative position between the target object and a focusing point by the illumination optical system in a height direction;
an acquisition unit configured to acquire, when a preparation sample is irradiated, at a predetermined position of the preparation sample, with the illumination light at a plurality of height positions different from each other, relationship information indicating a relationship between the height position and detected intensity based on a result of the detection of the return light by the detector, in which the preparation sample is the target object; and
a measurement unit configured to obtain, by using the relationship information, surface height information at the plurality of measurement positions based on a test detection result, the test detection result being the result of the detection of the return light by the detector obtained when the illumination light is applied to the plurality of measurement positions on a test sample while setting the height position for the test sample to a predetermined reference position, in which the test sample is the target object.

2. The measurement device according to claim 1, wherein
the relationship between the height position and the detected intensity is such a relationship that the detected intensity has a peak when the height position of the preparation sample is a specific height position, and
in the relationship between the height position and the detected intensity, the acquisition unit acquires, as the relationship information, a part belonging to either a lower height side or a higher height side than the specific height position.

3. The measurement device according to claim 2, wherein the relationship information shows such a relationship that the detected intensity increases as the height position increases, or such a relationship that the detected intensity decreases as the height position increases.

4. The measurement device according to claim 3, wherein the acquisition unit:
acquires, when a recess in the test sample is measured, relationship information showing such a relationship that the detected intensity decreases as the height position increases; and
acquires, when a protrusion in the test sample is measured, relationship information showing such a relationship that the detected intensity increases as the height position increases.

5. The measurement device according to claim 1, wherein
the detector comprises a plurality of pixels,
the acquisition unit acquires a plurality of pieces of relationship information each of which corresponds to a respective one of the plurality of pixels, and
the measurement unit obtains the surface height information by using the pieces of relationship information corresponding to the respective pixels.

6. The measurement device according to claim 5, wherein
the detector comprises a plurality of pixels arranged in one direction, and
the measurement device further comprises a scanning control unit configured to move a region on the test sample where an image is formed by the detector relative to the test sample so that the detector is moved in a scanning direction orthogonal to the one direction.

7. The measurement device according to claim 6, wherein
the measurement unit acquires the surface height information for each of the measurement positions each of which corresponds to a position of a respective one of the plurality of pixels, and
the measurement device further comprises an output unit configured to output an image in which the surface height information of each of the measurement positions is expressed in gradation on a coordinate plane in which positions on the test sample corresponding to the positions of the plurality of pixels arranged in the one direction are represented by first coordinates and positions on the test sample in the scanning direction are represented by second coordinates.

8. The measurement device according to claim 1, further comprising a determination unit configured to determine whether or not the test detection result exceeds a predetermined threshold.

9. The measurement device according to claim 8, wherein when the determination unit has made an affirmative determination, the measurement unit stops the calculation of the height information based on the test detection result at and after the affirmative determination.

10. The measurement device according to claim 8, wherein when the determination unit has made an affirmative determination, the position control unit controls the height position so that a height position different from the reference position at the time of the affirmative determination is set as a new reference position.

11. The measurement device according to claim 10, wherein the position control unit
controls, when the relationship information shows such a relationship that the detected intensity increases as the height position increases, the relative position between the test sample and the focusing point in the height direction so that a height position lower than the reference position at the time of the affirmative determination is set as the new reference position; or
controls, when the relationship information shows such a relationship that the detected intensity decreases as the height position increases, the relative position between the test sample and the focusing point in the height direction so that a height position higher than the reference position at the time of the affirmative determination is set as the new reference position

12. The measurement device according to claim 1, wherein the measurement unit specifies one of a plurality of combinations of pieces of height information and pieces of tilt information at the first measurement position, specified based on the test detection result, by using the height information and tilt information at the second measurement position close to the first measurement position.

13. The measurement device according to claim 1, wherein a reflectance of the test sample for the illumination light is roughly equal to that of the preparation sample for the illumination light.

14. The measurement device according to claim 13, wherein the test sample is the same object as the preparation sample.

15. A measurement method comprising:
by using a measurement device including an illumination optical system configured to apply illumination light to a target object, and a detection optical system configured to make a detector detect return light from the target object based on the illumination light;
controlling a height position, the height position being a relative position between the target object and a focusing point by the illumination optical system in a height direction;
acquiring, when a preparation sample is irradiated, at a predetermined position of the preparation sample, with the illumination light at a plurality of height positions different from each other, relationship information indicating a relationship between the height position and detected intensity based on a result of the detection of the return light by the detector, in which the preparation sample is the target object; and
obtaining, by using the relationship information, surface height information at the plurality of measurement positions based on a test detection result, the test
detection result being the result of the detection of the return light by the detector obtained when the illumination light is applied to the plurality of measurement positions on a test sample while setting the height position for the test sample to a predetermined reference position, in which the test sample is the target object.
